(19) United States
(12) Patent Application Publication
(10) Pub. No.: US 2010/0255191 A1
(43) Pub. Date: Oct. 7, 2010

(54) APPARATUS AND METHOD FOR MANUFACTURING DISPLAY DEVICE SUBSTRATE

(75) Inventor: Jae-Hoon JUNG, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/817,624

(22) Filed: Jun. 17, 2010

Related U.S. Application Data
(62) Division of application No. 11/550,994, filed on Oct. 19, 2006.

(30) Foreign Application Priority Data
Oct. 24, 2005 (KR) 10-2005-0100400

(51) Int. Cl. B05D 5/06

(52) U.S. Cl. 427/162

(57) ABSTRACT

An apparatus for manufacturing a display device substrate includes a vacuum chamber, a substrate rotating unit located within the vacuum chamber to rotate a substrate that is maintained in an erect state, and a vapor supply unit to supply an organic vapor to a surface of the substrate.

### CROSS-REFERENCE TO RELATED APPLICATIONS

This application is a divisional of U.S. patent application Ser. No. 11/550,994 filed Oct. 19, 2006 and claims priority from and the benefit of Korean Patent Application No. 2005-0100400, filed on Oct. 24, 2005, which are hereby incorporated by reference for all purposes as if fully set forth herein.

### BACKGROUND OF INVENTION

1. Field of Invention

The present invention relates to an apparatus and a method for manufacturing a display device substrate and, more particularly, to an apparatus and a method for manufacturing a display device substrate by forming an organic layer on a substrate arranged in an erect state.

2. Discussion of the Background

Liquid crystal displays (LCD), plasma display panels (PDP), and the like are used as flat panel displays. Recently organic light emitting diodes (OLED) have been spotlighted due to such advantages as having a wide viewing angle and rapid response, and being low voltage driven, light weight, and thin. The OLED is driven by self-emitting light from an emitting layer comprised of organic material which emits three colors. The OLED may be a passive matrix or an active matrix device according to its driving method. Further, the OLED may be a low molecular weight OLED and a polymer OLED according to the molecular weight of the hole injection layer (HIL), emitting material layer (EML), and the like.

The organic layer of the low molecular weight OLED may be formed by a thermal evaporation method of applying heat to a source material that is to be deposited on the display device substrate. According to this method, the evaporated source material forms the solid phase organic layer by a phase change while contacting the display device substrate of low temperature. In this method, the display device substrate is held horizontally, and the source material supplies an organic vapor from below the display device substrate.

The organic layer should be formed with uniform thickness, for example, with deposition thickness of ±5 μm. To this end, the display device substrate should not be allowed to sag during the evaporation process.

However, when manufacturing larger display device substrates, the organic layer may be formed having an uneven thickness because the center region of the substrate may sag.

### SUMMARY OF THE INVENTION

The present invention provides a display device substrate manufacturing apparatus that may be capable of forming an organic layer with substantially uniform thickness irrespective of the size of the display device substrate.

The present invention also provides a display device substrate manufacturing method that may be capable of forming an organic layer with substantially uniform thickness irrespective of the size of the display device substrate.

Additional features of the invention will be set forth in the description which follows, and in part will be apparent from the description, or may be learned by practice of the invention.

The present invention discloses an apparatus for manufacturing a display device substrate including a vacuum chamber, a substrate rotating unit located within the vacuum chamber to rotate a substrate that is maintained in an erect state, and a vapor supply unit to supply an organic vapor to a surface of the substrate.

The present invention also discloses a method for manufacturing a display device substrate including maintaining a substrate in an erect state, and forming an organic layer on the erect substrate by supplying an organic vapor to the substrate while rotating the substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a structure diagram of a manufacturing apparatus according to a first exemplary embodiment of the present invention.

FIG. 2 is a diagram for illustrating a rotation of a substrate in the manufacturing apparatus of FIG. 1.

FIG. 3 is a diagram for illustrating a vapor supplying unit in the manufacturing apparatus of FIG. 1.

FIG. 4 is a diagram for illustrating a cooling unit in the manufacturing apparatus of FIG. 1.

FIG. 5 is a diagram for illustrating a disposition of a cooling unit and a vapor supplying unit in the manufacturing apparatus of FIG. 1.

FIG. 6 and FIG. 7 are diagrams for illustrating how to form an organic layer on a substrate using a manufacturing apparatus according to the first exemplary embodiment of the present invention.

FIG. 8 is a diagram for illustrating a vapor supplying unit in a manufacturing apparatus according to a second exemplary embodiment of the present invention.

FIG. 9 is a structure diagram of a manufacturing apparatus according to a third exemplary embodiment of the present invention.

### DETAILED DESCRIPTION OF THE ILLUSTRATIVE, NON-LIMITING EMBODIMENTS OF THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

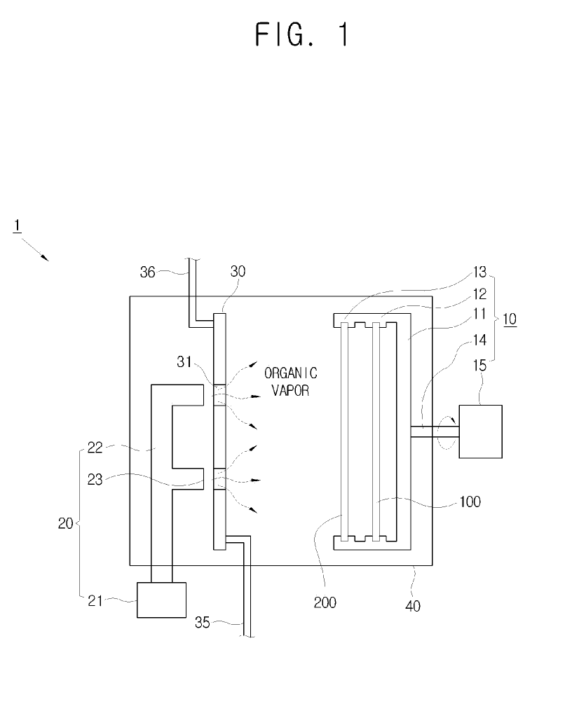

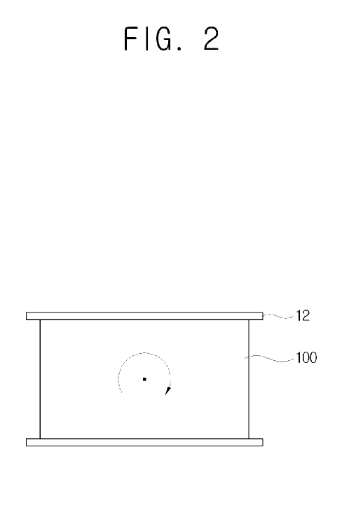

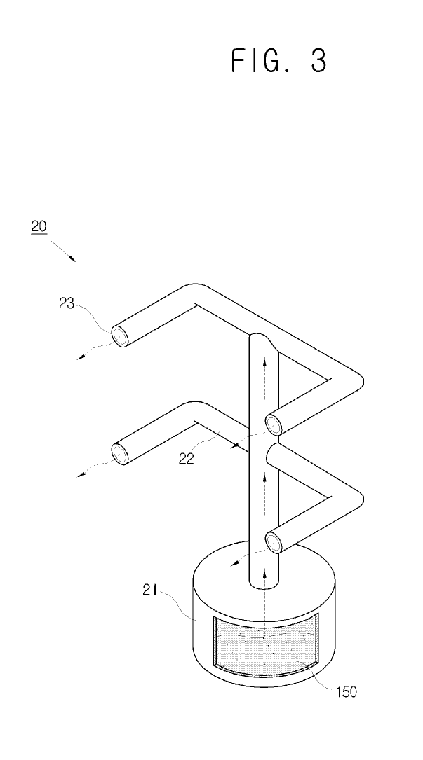

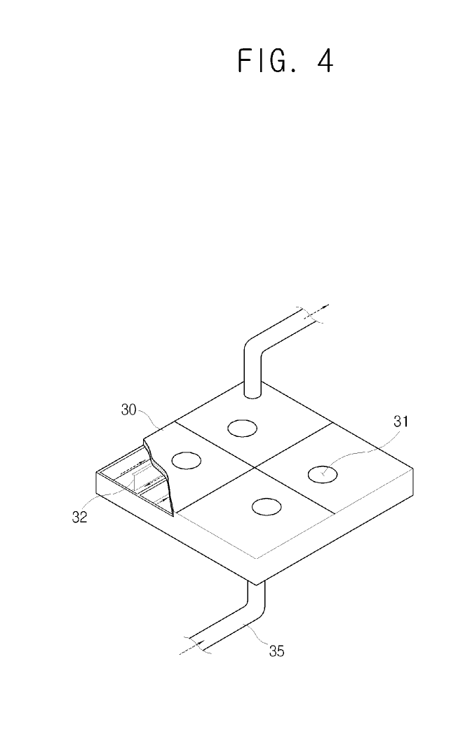

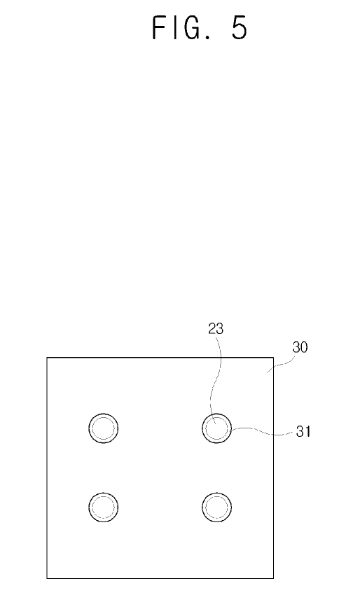

The apparatus for manufacturing a display device substrate according to a first exemplary embodiment of the present invention will be described referring to FIG. 1, FIG. 2, FIG. 3, FIG. 4, and FIG. 5.

FIG. 1 shows a structure diagram of a manufacturing apparatus according to the first exemplary embodiment of the present invention, FIG. 2 is a diagram for illustrating a rotation of a substrate in the manufacturing apparatus of FIG. 1, FIG. 3 is a diagram for illustrating a vapor supply unit in the manufacturing apparatus of FIG. 1, FIG. 4 is a diagram for illustrating a cooling unit in the manufacturing apparatus of FIG. 1, and FIG. 5 is a diagram for illustrating a disposition of a cooling unit and a vapor supply unit in the manufacturing apparatus of FIG. 1.

Referring to FIG. 1, FIG. 2, FIG. 3, FIG. 4, and FIG. 5, the apparatus 1 for manufacturing the display device substrate according to the first exemplary embodiment of the present invention includes a substrate rotating unit 10 for supporting and rotating the substrate 100, a vapor supply unit 20 for supplying an organic vapor to the substrate 100 in front of the substrate rotating unit 10, a cooling unit 30 located between the vapor supply unit 20 and the substrate rotating unit 10, and a vacuum chamber 40 for enabling the organic vapor to be supplied in a vacuum state.

The substrate rotating unit 10 supports and rotates the substrate 100 and a shadow mask 200 in an erect state.

The substrate rotating unit 10 includes a base plate 11, which is substantially rectangular-shaped, a substrate holder 12 provided in opposite sides of the base plate 11 for holding and supporting the substrate 100, a mask holder 13 provided in front of the substrate holder 12 for holding and supporting opposite sides of the shadow mask 200, a rod-shaped rotation transmitting axis 14, which is connected to a rear portion of the base plate 11, and a rotation driving unit 15 with which the base plate 11 is coupled via the rotation transmitting axis 14.

The substrate holder 12 and the mask holder 13 hold the substrate 100 and the shadow mask 200 in a flat state, respectively. The substrate 100 and the shadow mask 200 are held substantially parallel to each other. The substrate holder 12 and the mask holder 13 support the substrate 100 and the shadow mask 200 in the erect state, that is, support them to be substantially perpendicular to the horizontal plane.

The substrate 100 and the shadow mask 200 are rotated by driving the rotation driving unit 15. The rotation is performed in a condition that the substrate 100 and the shadow mask 200 are maintained in the erect state. The rotation axis shown in FIG. 2 coincides with a center of the substrate 100. The substrate 100 is preferably rotated within a plane containing its own surface, but is not limited to rotating in this manner. The substrate 100 and the shadow mask 200 are maintained substantially in parallel to each other to keep the same distance between the substrate 100 and the shadow mask 200.

The rotation driving unit 15 may be configured of a motor and the like.

The vapor supply unit 20 supplies the organic vapor to the substrate 100. The vapor supply unit 20 includes a vapor generating unit 21 for generating the vapor, a vapor discharging port 23 for discharging the organic vapor, and a connecting unit 22 for connecting the vapor generating unit 21 with the vapor discharging port 23, as shown in FIG. 3.

The vapor generating unit 21 is cylinder-shaped and contains a source material 150 of solid phase or liquid phase, and forms the organic vapor from the source material 150 utilizing a heating unit (not shown). In the first exemplary embodiment, the vapor generating unit 21 is located outside the vapor chamber 40.

The organic vapor, which travels in a vertical direction from the vapor generating unit 21, is delivered into the vapor discharging port 23 via the connecting unit 22 by changing flow direction to a horizontal direction. The connecting unit 22 extends from outside the vacuum chamber 40 into inside the vacuum chamber 40.

Since the vapor generating unit 21 is located outside the vacuum chamber 40, it may be easy to supplement or exchange the source material 150. The vapor generating unit 21 and the connecting unit 22 can be configured to be detachably coupled with each other.

The vapor discharging port 23 discharges the organic vapor that is delivered through the connecting unit 22 towards the substrate 100. As shown in FIG. 5, the vapor discharging port 23 is circular and four vapor discharging ports 23 constitute a square, which are located on the same plane. A plane constituted by 4 vapor discharging ports 23 is substantially parallel to the surface of the substrate 100.

The vapor discharging port 23 is disposed in a horizontal direction and the organic vapor discharged via the vapor discharging port 23 may travel uniformly in every direction of 360 degrees about the vapor discharging port 23.

In such vapor supply unit 20, the vapor discharging port 23 is disposed in the horizontal direction and the source material is located in the vapor generating unit 21. Therefore, it may be possible to prevent the source material 150 from leaking through the vapor discharging port 23. Further, it is suitable for larger substrates 100 since the organic vapor can be supplied to a larger space using a plurality of vapor discharge ports 23.

The cooling unit 30 is located between the vapor discharging port 23 and the substrate rotating unit 10. High heat may be used to obtain the organic vapor from the source material 150. Hence, the connecting unit 22 and the vapor discharging port 23 through which the organic vapor passes may also have high temperature. Since the shadow mask 200 and the substrate 100 may be very thin, the heat of the vapor supply unit 20 may transform them. Thus, the cooling unit 30 may be disposed adjacent to the vapor discharging port 23 so that it may prevent the high heat of the vapor supply unit 20 from reaching the substrate 100 or the shadow mask 200. Further, it is possible to reduce the distance between the vapor discharging port 23 and the substrate 100 by using cooling unit 30, thereby improving use efficiency of the source material 150.

The cooling unit 30 is plate-shaped and disposed substantially parallel to the substrate 100. The cooling unit 30 may be disposed closer to the vapor supply unit 20 than the substrate rotating unit 10 to increase the cooling efficiency and not to prevent the flow of organic vapor.

The cooling unit 30 includes a vapor pass-through port 31 corresponding to the vapor discharging port 23 for carrying the organic vapor discharged from the vapor discharging port 23. The vapor discharging port 23 and the vapor pass-through port 31 are disposed to correspond one-to-one mutually.

The cooling unit 30 is provided with a coolant such as cooling water from a coolant inflow pipe 35 and passes the coolant through a coolant outflow pipe 36. A partition wall 32 is disposed within the cooling unit 30 to form a flow passage of the coolant. The coolant from the coolant inflow pipe 35 is discharged to the outside through the coolant outflow pipe 36 after passing the interior of the cooling unit 30 in a zigzag form.

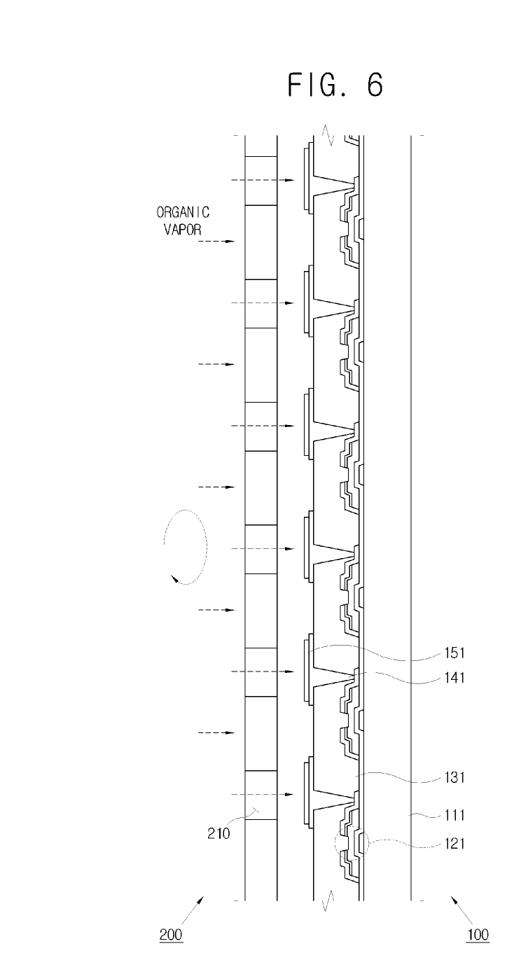

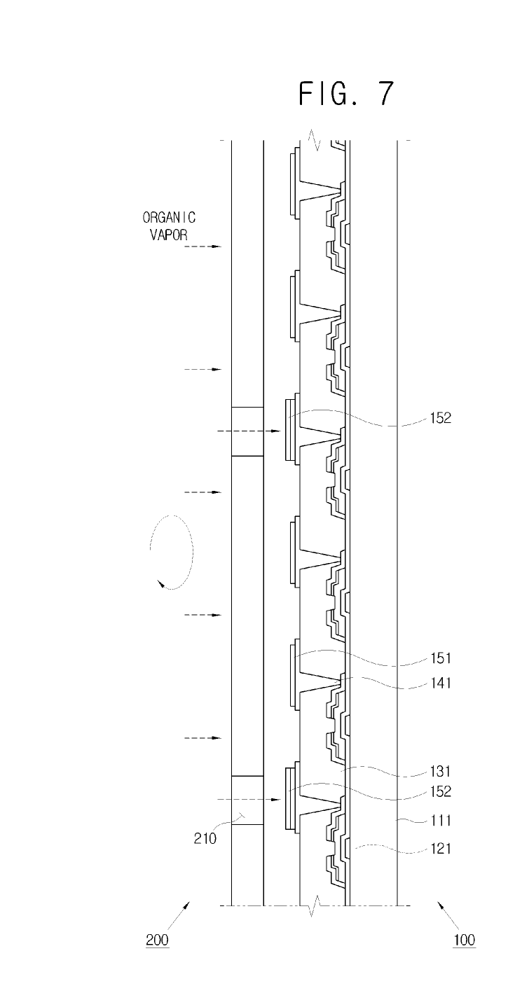

Using the manufacturing apparatus according to the first exemplary embodiment of the present invention, a method of forming the organic layer on the substrate will be now described referring to FIG. 6 and FIG. 7.

FIG. 6 shows a method of forming an organic layer that may be commonly formed on every pixel, such as a hole injection layer, a hole transport layer, an electron injection layer, or an electron transport layer.

The substrate 100 includes an insulating substrate 111 of plastic or glass, a thin film transistor 121 formed on the insulating substrate 111, a passivation film 131 covering the thin film transistor 121, and a pixel electrode 141 located on the passivation film 131 and coupled with the thin film transistor 121.

The pixel electrodes 141 are substantially rectangular-shaped, disposed in the form of matrix, and exposed to the outside.

The shadow mask 200 is located in front of the substrate 100. The shadow mask 200 includes a mask pass-through port 210, and the substrate 100 and the shadow mask 200 are aligned so that the pixel electrode 141 and the mask pass-through port 210 may correspond to each other.

The substrate 100 and the shadow mask 200 are rotated while being maintained in the erect state by means of the substrate rotating unit 10. Consequently, the substrate 100 and the shadow mask 200 may be prevented from sagging and may be maintained with a constant distance between them.

As the substrate 100 and the shadow mask 200 rotate, organic vapor is supplied through the vapor supply unit 20. The organic vapor passes through the mask pass-through port 210 of the shadow mask 200 and undergoes a phase change to a solid due to contact with the pixel electrode 141 to form an organic layer 151. Here, since the heat of the vapor supply unit 20 is interrupted by the cooling unit 30, it may be possible to decrease a problem that the substrate 100 and the shadow mask 200 are transformed by the heat.

The organic layer 151 can be formed with a substantially uniform thickness, since the substrate 100 and the shadow mask 200 may be maintained without sagging and transforming. For example, the organic layer 151 can be formed with deposition thickness uniformity of ±5 μm.

FIG. 7 illustrates a case of another organic layer formed in certain pixels, such as organic emitting layer.

On the substrate 100 and the pixel electrode 141 is formed the organic layer 151, which is formed via processes such as those of FIG. 6.

The number of the mask pass-through ports 210 in the shadow mask 200 is less that that of the pixel electrodes 141, and more specifically ⅓ the number of pixel electrodes 141.

The substrate 100 and the shadow mask 200 rotate while being maintained in an erect state by means of the substrate rotating unit 10. Therefore, the substrate 100 and the shadow mask 200 may be prevented from transforming and may be maintained at with a constant distance between them.

As the substrate 100 and the shadow mask 200 rotate, the organic vapor, e.g., the organic vapor from the source material, which emits red light, is supplied through the vapor supply unit 20. The organic vapor passes through the mask pass-through port 210 of the shadow mask 200 and undergoes the phase change to a solid due to contact with the organic layer 151 to form a new organic layer 152. At this time, since the heat of the vapor supply unit 20 is interrupted by the cooling unit 30, it may be possible to decrease the problem that the substrate 100 and the shadow mask 200 are transformed by the heat.

Thereafter, the same processes may be repeated on the source material for emitting blue light and green light, and subsequently a relative location between the substrate 100 and the shadow mask 200 may be changed little by little.

The organic layer 152 can be formed with a substantially uniform thickness, since the substrate 100 and the shadow mask 200 may be formed without sagging and transforming. For example, the organic layer 152 can be formed with deposition thickness uniformity of ±5 μm.

After forming the organic matter, the OLED may be completed upon forming a common electrode via a method such as sputtering.

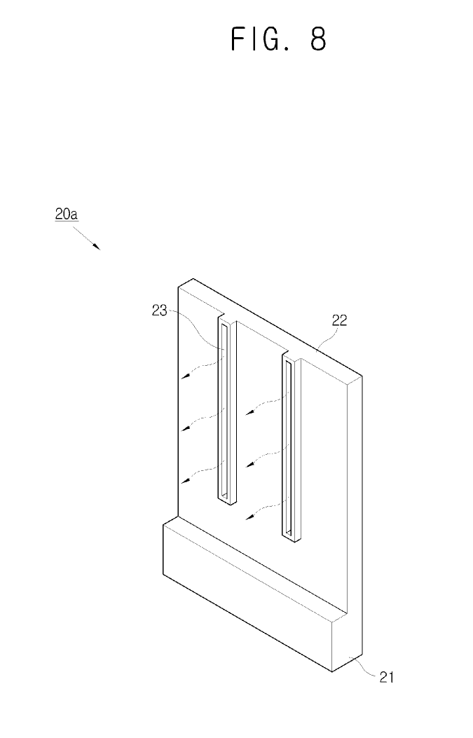

The vapor supply unit of a manufacturing apparatus according to a second exemplary embodiment of the present invention will be now described referring to FIG. 8.

The vapor supply unit 20a includes the vapor generating unit 21 for generating the vapor, the vapor discharging port 23 for discharging the organic vapor, and the connecting unit 22 for connecting the vapor generating unit 21 with the vapor discharging port 23.

The vapor generating unit 21 is rectangular shaped, and the connecting unit 22 is square plate-shaped. The vapor discharging port 23 extends in a vertical direction with a linear slit rather than the circular shape in such a way that two vapor discharge ports 23 are substantially parallel to each other.

It will be appreciated that the vapor discharging port 23 may alternatively extend in the horizontal direction. Further, the vapor discharging port 23 can include both circular shapes and linear slits.

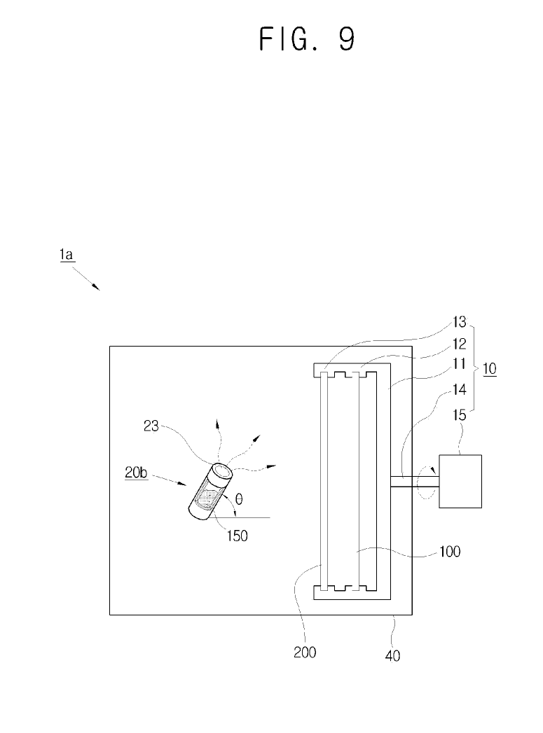

FIG. 9 is a structure diagram of a manufacturing apparatus according to a third exemplary embodiment of the present invention.

The vapor supply unit 20b in the manufacturing apparatus la according to the third exemplary embodiment is prepared in a form of a point source. The source material 150 of liquid phase or solid phase used to form the organic vapor is located within the vapor supply unit 20b.

The vapor discharging unit 23 is directed towards a front upper portion of the vacuum chamber with a certain degree (A). The purpose of it is to prevent the source material 150 from leaking from the vapor supply unit 20b.

A plurality of vapor supply units 20b may be utilized, unlike this embodiment. In this case, the vapor supply units 20b can be disposed at a constant distance from each other.

Although the above-mentioned exemplary embodiments are described with reference to an OLED substrate, it will be appreciated that the invention can also be applied to other display device substrates including an organic layer deposited by heat vaporization method, such as a substrate for a liquid crystal display.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for manufacturing a display device substrate, comprising:
maintaining a substrate in an erect state; and
forming an organic layer on the erect substrate by supplying an organic vapor to the substrate while rotating the substrate.

2. The method of claim 1, wherein the substrate is rotated within a same plane as a surface of the substrate.

3. The method of claim 1, wherein the substrate rotates about an axis that passes through a center of the substrate.

4. The method of claim 1, wherein the organic vapor is supplied through a plurality of vapor discharging ports located in front of the substrate.

5. The method of claim 1, wherein the organic vapor is supplied to the substrate through a shadow mask located in front of the substrate.

6. The method of claim 5, wherein forming the organic layer is performed in a state with a constant distance between the substrate and the shadow mask.

7. The method of claim 1, wherein forming the organic layer is performed in a state that the substrate is substantially flat.
